(19) United States
(12) Patent Application Publication
(10) Pub. No.: US 2002/0004795 A1
(43) Pub. Date: Jan. 10, 2002

(54) Document reference service

(76) Inventor: Robert Francis Squibbs, Bristol (GB)

Correspondence Address: HEWLETT-PACKARD COMPANY, Intellectual Property Administration, P.O. Box 272400, Fort Collins, CO, 80527-2400, US

(21) Appl. No.: 09/896,469

(22) Filed: Jun. 29, 2001

(30) Foreign Application Priority Data
Jul. 7, 2000 (GB) 0016755.1

(51) Int. Cl. G06F 17/30

(52) U.S. Cl. 707/3; 707/10

(57) ABSTRACT

A document reference service is provided that enables users to find information of relevance amongst their own collection of documents. The service is provided by a service system that keeps a record of documents held by the user and a document database including copies of those documents or indexes for those documents. When the user wishes to find information relevant to a particular topic, they send a topic indicator to the service system which conducts a search amongst the documents known to be available to the user. A list of relevant document references is returned to the user for the user to look up in their own copies of the documents concerned. The service can be provided by a bookstore in respect of books it has sold to the user.

### FIELD OF THE INVENTION

The present invention relates to a service for finding items of interest in documents. As used herein, the term “document” is to be understood to be unrestricted as regards length and medium on which it is available to a subscriber to the service; thus the term document specifically includes both physical and electronic documents.

### BACKGROUND OF THE INVENTION

It is a truism that a reference book is only as good as its index. This truism is an expression of the fact that unless information in a book or other document is capable of being retrieved when wanted, it is worthless. This applies equally to the general store of information that individuals and other parties have in the collection of documents they hold—unless there is some effective way of accessing the information about a topic of interest, the document collection is for all practical purposes worthless.

Of course, many effective catalogue and indexing systems exist. Furthermore, with the advent of documents in electronic form and the availability of high-speed search tools for searching such documents, the tools exist for rapid retrieval of relevant information. Despite this, most individuals and organisations continue to flounder amongst the information assets they have available, largely because they have neither the time nor resources to organise a proper system for accessing their information assets effectively.

It is an object of the present invention to provide a way for parties to more effectively access their information assets.

### SUMMARY OF THE INVENTION

According to the present invention, there is provided a document reference service method provided by a service system accessible over a communications infrastructure, the method comprising the following steps carried out under the control of the service system:

keeping both a record identifying documents already held by a party independently of the service system and a document database including copies of those documents or indexes therefore;

receiving a request from said party over the communications infrastructure, the request including an interest indicator;

electronically searching the document database to ascertain document reference data indicative of where, in the documents held by the requesting party, as indicated by said record, information relevant to the interest indicator can be found, and

returning the reference data to the requesting party.

The service is, for example, provided by a bookstore in respect of books it has sold to the party.

According to another aspect of the present invention, a document reference service system comprising:

a communications interface enabling a remote party to access the service system;

a storage subsystem keeping both a record identifying documents already held by said remote party independently of the service system and a document database including copies of those documents or indexes therefore;

a search engine for electronically searching the document database to ascertain document reference data indicative of where, in the documents held by said party, as indicated by said record, information relevant to a specified interest indicator can be found, and

a request handler for receiving from said party, via the communications interface, a request including an interest indicator, the request processor being responsive to said request to use the search engine to determine document reference data relevant to the interest indicator received in the request and to return this document reference data to the remote party via the communications interface: re is provided.

### BRIEF DESCRIPTION OF THE DRAWINGS

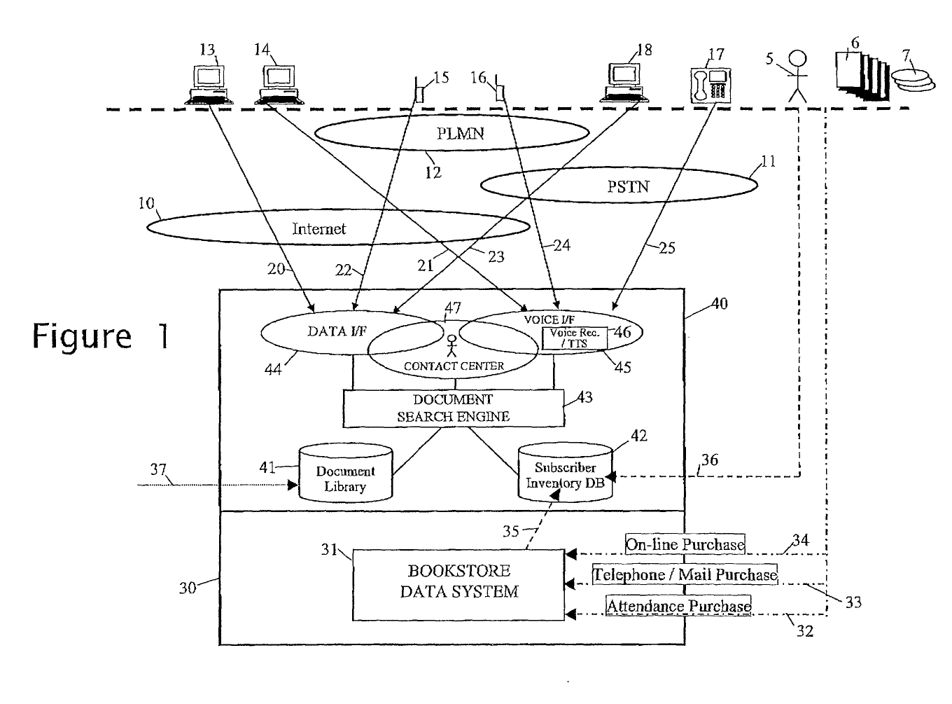

A document reference service method and system both embodying the invention will now be described, by way of non-limiting example, with reference to the accompanying diagrammatic drawings, the sole FIGURE of which (FIG. 1) is a diagrammatic representation of the overall system.

### BEST MODE OF CARRYING OUT THE INVENTION

Referring to the drawing, a user 5 has a collection of documents in the form of physical books 6 and electronic books 7. The user 5 may be an individual or an organisation. In the present example, the user 5 has purchased the books 6, 7 from a bookstore 30 through various channels, including by personal attendance (arrow 32), by telephone or mail order (arrow 33), or by on-line purchase (arrow 34) such as through a website run by bookstore 30.

The details of the books purchased by user 5 have been recorded by the bookstore in its data processing system 31.

User 5 decides to subscribe to a document reference service offered by the bookstore and available via a service system 40. This service system may be run by the bookstore itself or provided by a third party. To set up the document reference service for the user 5, a list of the books 6, 7 purchased by the user from the bookstore 30 is copied from the data system of the bookstore to a subscriber inventory database 42 of the service system (see arrow 35). Database 42 maintains for each subscriber (e.g. user 5) a record of the documents they currently hold (this record may or may not be complete). As well as receiving document information from the bookstore data system 31, the database can also receive input from the user 5 about other documents it holds (see arrow 36) that were purchased form other sources (for commercial reasons, the bookstore 30 may decide not to offer this facility, thereby encouraging purchase from itself).

For each document listed in the database 42, the service system obtains (or seeks to obtain) an electronic copy of the document or of an index for the document, these items being provided, for example, by the document publisher (arrow 37) and stored in document database 41.

When user 5 wishes to find out information about a particular item of interest, the user sends a search request to the document reference service 40 over an appropriate communication path. In FIG. 1, a number of different paths are shown. Thus, data-based requests can be made to a data interface 44 of the service system (for example, a web server):

using PC 13 that connects to the data interface 44 via internet 10 (arrow 20);

using a WAP-enabled cell phone 15 connecting via Public Land Mobile Network PLMN 12 and internet 10 to the data interface 44 of service system 40 (arrow 22);

using a PC 18 with a dial-up internet connection via the Public Switched Telephone Network PSTN 11 (arrow 23).

Voice-based requests can also be made to voice interface 45 of the service system 40:

using a standard telephone 17 connecting via the PSTN 11 to the service system 40 (arrow 25);

using a mobile cell phone 16 connecting via PLMN 12 and PSTN 11 to the service system 40 (arrow 24);

using PC 14 with internet telephony capability that connects via internet 10 to the voice interface 45 of the service system (arrow 21).

Regardless of whether the request is received by the data interface 44 or by the voice interface 45, the request may be handled either by a human representative in a contact center 47 or automatically, in order to generate an appropriate search-engine request for processing by a document search engine 43 of the service system. This search-engine request is based on the identity of the requesting user and on the interest indicator included in the user request. Of course, as a preliminary to handling the user request, the identity of the user is checked in an appropriate manner, for example, by means of a password (the service system keeping a copy of each user's password in a subscriber database, not shown). For direct telephone calls, calling line ID can be used to check user identity.

With respect to the automatic handling of the user request, the voice interface 45 is provided with an appropriate voice-recognition/text-to-speech subsystem 46 for this purpose. The data interface 44 effects automatic processing, for example, on the basis of a web form sent by the user, the processing of such forms being well understood by persons skilled in the art.

The search engine 43 processes a search-engine request by searching those documents/document indexes contained in document database 41 for which the user has document copies, in order to ascertain references (document ID, page number in document) relevant to the interest indicator provided by the user. When the search is complete, the search engine returns the references found and the appropriate interface 44, 45 is then used to send the reference data back to the user 5.

The interest indicator included in the request sent by user 5 need not be limited to a word, group of words, or even a Boolean expression of words. For example, the interest indicator could be a geographic location expressed in an appropriate set of coordinates. Of course, it is unlikely that such location coordinates will produce a direct match in any search and therefore the service system is arranged first to translate the coordinates into key terms for the location concerned—these key terms are for example, names of places close to the location or of people and events associated with the location. The translation from location to search term is done, for example by a database look-up in a location/key-term database (not shown). Effecting such location-based document reference look-ups forms part of the subject matter of our co-pending UK patent application No. 0012749.8 filed May 26, 2000.

It will be appreciated that many variants are possible to the above described embodiment of the invention. Thus, for example, the service system 40 can be run entirely separately from any bookstore with the user providing all the necessary information about the documents they hold when registering for the service.

The service system can also be arranged to inform a requesting user, about one or more documents which are of particular relevance to the indicated interest area and which the user does not currently possess; the user could even be given the opportunity to buy these documents from the bookstore 30.

1. A document reference service method provided by a service system accessible over a communications infrastructure, the method comprising the following steps carried out under the control of the service system:
keeping both a record identifying documents already held by a party independently of the service system and a document database including copies of those documents or indexes therefore;
receiving a request from said party over the communications infrastructure, the request including an interest indicator;
electronically searching the document database to ascertain document reference data indicative of where, in the documents held by the requesting party, as indicated by said record, information relevant to the interest indicator call be found, and
returning the reference data to the requesting party.

2. A method according to claim 1, wherein the service is provided by a bookstore and said record of documents held by the party comprises a record of books purchased by the party from the bookstore.

3. A method according to claim 1, wherein the party communicates their request by voice either through a service representative or through a voice-recognition/text-to-speech subsystem.

4. A method according to claim 1, wherein the party communicates their request as a web form for either automatic processing or for processing by a service representative.

5. A multi-party document reference service method wherein a service system provides for each of multiple parties a document reference service according to the method of claim 1, the service system keeping a respective said record for each such party.

6. A method according to claim 1, further comprising the steps of adding a document item to the record of documents at the request of said party; determining whether the document concerned, or an index thereof, currently exists in the document database; and if the document or an index thereof is not present, seeking to obtain an electronic copy or index of the document or index from en external source.

7. A method according to claim 1, wherein in addition to returning document reference data to the requesting party concerning documents held by that party, the service system also indicates at least one further document of relevance to the request.

8. A method according to claim 1, wherein the said interest indicator is a location, the service system translating this location into one or more key terms associated with that location as determined from a database relating location to key terms, the service system thereafter carrying out its search of the document database to generate said reference data indicating where information relevant to at least one said key term can be found.

9. A document reference service system comprising:
a communications interface enabling a remote party to access the service system;
a storage subsystem keeping both a record identifying documents already held by said remote party independently of the service system and a document database including copies of those documents or indexes therefore;
a search engine for electronically searching the document database to ascertain document reference data indicative of where, in the documents held by said party, as indicated by said record, information relevant to a specified interest indicator can be found, and
a request handler for receiving from said party, via the communications interface, a request including an interest indicator, the request processor being responsive to said request to use the search engine to determine document reference data relevant to the interest indicator received in the request and to return this document reference data to the remote party via the communications interface.

10. A system according to claim 9, wherein the service system is provided by a bookstore and said record of documents held by the party comprises a record of books purchased by the party from the bookstore.

11. A system according to claim 9, wherein the communications interface comprises a voice channel to a service-representative station.

12. A system according to claim 9, wherein the communications interface comprises a voice channel to a voice-recognition/text-to-speech subsystem.

13. A system according to claim 9, wherein the communications interface comprises a web interface for receiving a said request as a web form.

14. A system according to claim 9, wherein the storage subsystem is arranged to hold a said record for each of multiple parties and the document data is arranged to hold copies or indexes for the documents identified in all the records, the request handler being adapted to identify a party submitting a request and to cause the search engine to constrain its search to the documents indicated by the record associated with the identified party.

15. A system according to claim 9, wherein the said interest indicator is a location, the service system including a location database relating location to key terms and a translation subsystem for using the location database to translate the location received as an interest indicator in a request into one or more key terms associated with that location, the request handler being operative to cause the search engine to use said one or more key terms to carry out its search of the document database to generate said document reference data.
